(19) United States
(12) Patent Application Publication
(10) Pub. No.: US 2002/0107763 A1
(43) Pub. Date: Aug. 8, 2002

(54) Web based system and method for configuring and determining availability of configurable products

(75) Inventors: David Lauriston Palmer, Mission Viejo, CA (US); Thomas Vollmer, Irvine, CA (US)

Correspondence Address: TED R. RITTMASTER, Foley & Lardner, 2029 Century Park East, Suite 3500, Los Angeles, CA, 90067-3021, US

(73) Assignee: ITT Manufacturing Enterprises, Inc.

(21) Appl. No.: 09/737,249

(22) Filed: Dec. 13, 2000

(51) Int. Cl. G06F 17/60

(52) U.S. Cl. 705/29

(57) ABSTRACT

A system and process for determining availability of configurable products allows a customer to access the system through the internet, and to receive product availability information for multiple suppliers by providing the product number. The system preferably includes a presentation layer that provides communication with a client through the internet, a configurator for generating a parts list corresponding to a product number provided by the client, a data access layer for obtaining parts inventory data for parts included in the parts list from at least one supplier parts database, and an availability manager for determining product availability information for each of the suppliers using the parts list and the suppliers' respective parts inventory data. Rules based configurators for generating parts lists are also disclosed.

### FIELD OF THE INVENTION

The invention pertains to configuring and distributing configurable products.

### BACKGROUND TECHNOLOGY

Many products available today are configurable by the customer. In general, this means that the product has a number of attributes for which various options are available. Personal computers are an example of a configurable product. For example, a customer may be allowed to specify a variety of options relating to attributes such as the type of processor, memory, storage devices, and peripherals. Electrical connectors are another example of a configurable a product. For example, a customer may specify options relating to attributes such as gender (e.g. plug vs. receptacle), termination (e.g. cable vs. circuit board, straight vs. right angle), and numbers of signal lines and coaxial lines.

Traditionally, the assembly and distribution of configurable products has been facilitated by the use of configurators. A conventional configurator is a stand-alone computer application, distributed on floppy disk or cd rom, that is used by purchasers of a configurable product to understand the various available options and to design the product that meets their needs. In response to the information specified by the customer, the configurator can provide information such as product specifications and pricing. Conventional configurators have a number of shortcomings. Particularly, stand alone configurators do not provide real time information about available options or prices, and do not provide any information concerning the availability of a desired product.

E-commerce systems typically employ an internet accessible server, such as a web server, to facilitate product distribution and provide real time product information. Some e-commerce systems, such as the one maintained by AMP, Incorporated of Harrisburg, Pa., include a configurator. The AMP system also provides limited finished product availability information by querying suppliers (distributors of a finished product and/or factories that produce a finished product) for information regarding their inventories of the finished product. However, finished product inventory does not reflect the supplier's ability to produce a requested product from existing parts inventory, and in the case of most configurable products, it is likely that the supplier utilizes a just-in-time production system whereby finished products are only produced in response to orders, and therefore maintains very little finished product inventory.

### SUMMARY OF THE DISCLOSURE

Embodiments of the present invention provide a system and related processes and products that improve over the stand alone configurator and e-commerce systems described above, in that when a customer configures a desired product, suppliers may be queried to determine their inventories of parts necessary to produce the product, and from this information the availability of the product from each supplier may be determined. The system preferably includes a rules-based configurator that dynamically generates a parts list in response to user input specifying a product number. Further embodiments provide a rules based configurator and related processes and products.

In one embodiment a system for determining availability of a configurable product preferably includes a processor and stored programming code providing a presentation layer that provides communication with a client through the internet, a configurator for generating a parts list corresponding to a product number provided by the client, a data access layer for obtaining parts inventory data for parts included in the parts list from supplier parts databases, and an availability manager for determining product availability information for each of the suppliers using the parts list and the supplier's inventory data. A system in accordance with this embodiment allows a customer to access the system through the internet, and to receive accurate availability information for a configurable product from multiple suppliers. The customer may specify the product number or the product's attributes.

In a related embodiment a process in a system for determining availability of a configurable product preferably includes receiving a product number from a client through the internet, generating a parts list corresponding to the product number, obtaining parts inventory data for the parts included in the parts list from supplier parts databases, determining product availability information for each of the suppliers using the parts list and the supplier's inventory data, and providing the availability information for each of the suppliers to the client through the internet. A process in accordance with this embodiment allows a customer to obtain accurate availability information for a configurable product from multiple suppliers through a centralized source via the internet by providing a product number. The customer may specify the product number or the product's attributes.

In another embodiment, a rules based configurator preferably comprises a part number database associating parts data with logical functions of field values, a processor, and stored programming instructions providing system components including a parsing engine generating product field values from a product number and a parts list engine applying the product field values to logical functions stored in the part number database to yield a parts list corresponding to the product number. In a related embodiment, a method for generating a parts list for a product preferably comprises generating product field values from a product number, applying the product field values to logical functions of field values stored in a part number database in association with parts data, retrieving parts data associated with each logical function for which application of the product field values produces a true result, and generating a parts list from the retrieved parts data.

In another embodiment, a rules based configurator preferably comprises a part number database associating parts data with part selectors, a selector database associating part selectors of the part number database with logical functions of field values, a processor, and stored programming instructions providing a parsing engine generating product field values from a product number, a selector engine applying the product field values to logical functions stored in the selector database to determine part selectors corresponding to the product number, and a parts list engine retrieving parts data corresponding to determined part selectors to generate a parts list corresponding to the product number. In a related embodiment, a method for generating a parts list for a product preferably comprises generating product field values from a product number, applying the product field values to logical functions of field values associated with part selectors to determine part selectors corresponding to the product number, retrieving parts data corresponding to determined part selectors to generate a parts list corresponding to the product number.

### DESCRIPTION OF THE DRAWINGS

FIG. 1 illustrates a system architecture in accordance with an embodiment of the invention;

FIG. 2 presents a flow diagram of processes in the system of FIG. 1;

FIG. 3 illustrates a rules based configurator in accordance with an embodiment of the invention;

FIG. 4 illustrates an embodiment of a field value database and example pseudocode for parsing a product number using the field value database;

FIGS. 5 and 6 illustrate alternative rules based configurators in accordance with embodiments of the invention; FIG. 7 illustrates a process in a selector engine of the embodiment illustrated in FIG. 6;

FIG. 8 illustrates a process by which an availability engine produces product availability information in accordance with an embodiment of the invention; and

FIG. 9 illustrates a system architecture in accordance with a further embodiment of the invention.

### DETAILED DESCRIPTION OF PREFERRED EMBODIMENTS

In preferred embodiments of the invention, it is assumed that a system for providing availability information for configurable products is operated by a manufacturer of parts that are supplied to distributors who assemble finished products, and that the manufacturer also assembles finished products at its own factories. As a result, the distributors and the factories are collectively treated as “suppliers” of finished products. It is also assumed that the factories and distributors generally assemble finished products in response to orders, and maintain very little finished product inventory. However, alternative embodiments may be applied to alternative distribution systems. For example, the system may be operated by a parts manufacturer that does not supply finished products. Alternatively, the system may be operated by a third party that is not involved in either manufacturing parts or supplying finished products.

### SYSTEM ARCHITECTURE

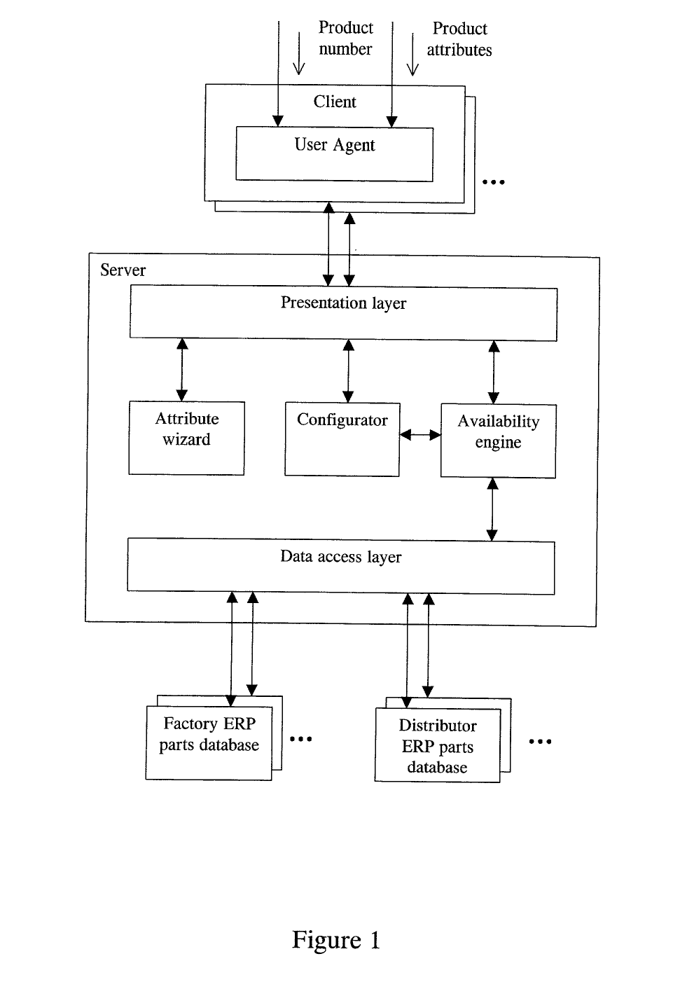

A basic architecture of a system in accordance with an embodiment of the invention is illustrated in FIG. 1. The architecture of FIG. 1 provides product specifications and product availability information for a configurable product in accordance with a product number generated by a user agent at a client operated by a customer. The product number is a character string that encodes the features of a product that distinguish it from other products. As discussed in more detail below, the information encoded in the product number is preferably extracted and interpreted through logical operations to generate a parts list and specifications for the product.

As shown in FIG. 1, the server communicates with clients, and with factory and distributor enterprise resource planning system (ERP) parts databases. Each client includes a user agent, such as a web browser, that resides on a customer computer system, and the server preferably communicates with the clients through the internet. Communication with the clients is preferably implemented through a presentation layer application such as a java servlet or java server pages. Communication with the manufacturer and distributor databases is conducted through the internet or through private networks and is preferably enabled through a data access layer application that uses a standard such as XML or java database connectivity (JDBC), or a proprietary mechanism where necessary, to issue queries directly to the parts databases and to receive query results.

The server further includes a configurator and an availability engine, both of which may be implemented as java applications. The configurator generates product specification data including a parts list based on the product number received from the client. The parts list is preferably provided as an XML document. The availability engine uses the parts list to provide parts data to the data access layer for use in queries to suppliers, and determines product availability using quantity data from the parts list and parts inventory data obtained from the supplier databases.

The server further includes an attribute wizard. The attribute wizard cooperates with user agents in client systems to generate a product number from product attributes entered by a user.

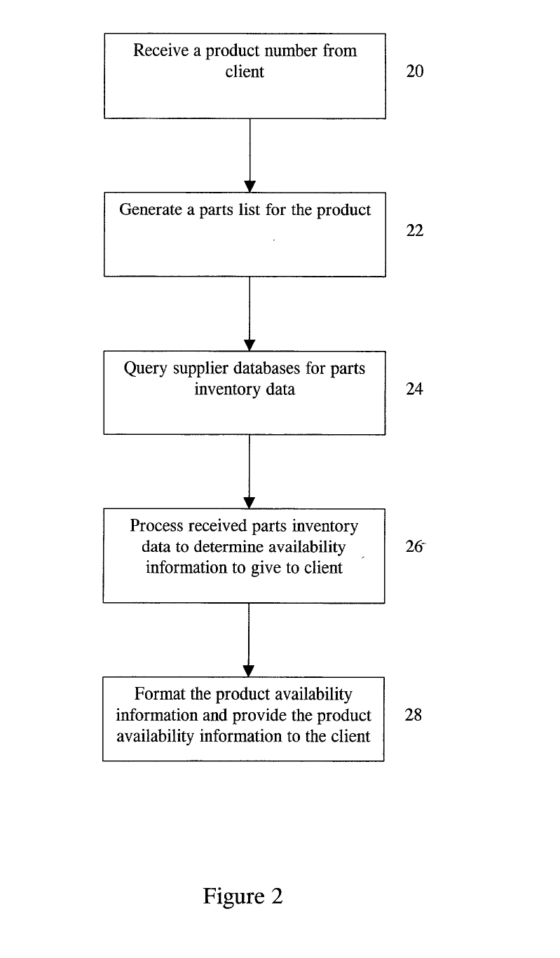

FIG. 2 presents a flow diagram of processes performed in the system illustrated in FIG. 1 to provide product availability information to a client upon receipt of a product number. Initially, the server receives 20 a product number from a client. The product number is provided to the configurator, where a parts list corresponding to the product number is generated 22. Upon receiving a request from the client for product availability information, the databases of supplier (factory and/or distributor) ERP systems are queried 24 by the data access layer for inventory data. The queries request inventory data for each part in the parts list. Received parts inventory data is processed 26 by the availability engine and the availability information that will be provided to the client is determined. The availability information is then formatted and provided 28 to the client by the presentation layer. Implementations of each of the aforementioned acts in accordance with preferred embodiments of the invention are described in detail below.

Client System

In accordance with an embodiment of the invention, the client system is implemented on customer data terminal equipment, such as a personal computer or workstation, that includes a network interface device and appropriate programming instructions for providing internet access. The client system further includes a user agent, such as a web browser, for rendering a graphical user interface generated by and transmitted from the server. The user agent preferably includes a java applet enabling interaction with the server attribute wizard.

From the perspective of a customer, the graphical user interface enables direct entry of a product number, or entry of product attributes from which a product number is then generated. The graphical user interface preferably enables some attributes to be specified by presenting lists of attributes from which the customer may choose. For example, in a system for configuring connectors, a customer may be enabled to choose such attributes as gender (e.g. plug or receptacle) and termination (e.g. cable or circuit board, straight or right angle). The graphical user interface also preferably enables the customer to specify some attributes by entering the value of the attribute directly. For example, in a system for configuring connectors, a customer may be enabled to enter values indicating a number of signal lines and a number of coaxial lines. The graphical user interface also preferably displays any portions of the product number that can be determined from currently specified attributes. In addition, once a product number has been specified or generated from attributes, the graphical user interface displays resulting information such as product specifications, and enables the user to request availability information.

Attribute Wizard

The attribute wizard of the server interacts with the user agent in the client system to generate a product number from attributes provided as input by a user. The wizard applies attribute logic to user-specified attributes to generate product number data consistent with the attributes, and to generate data that is used by the presentation layer to format the user interface that will be displayed in the client. These functions are performed on the set of all specified attributes each time the contents of the set of specified attributes are changed, such as when an additional attribute is specified, or when a previously specified attribute is withdrawn from the attributes already specified. As a result, upon each change in the specified attributes, the choices of attributes made available for selection through the user interface are updated such that other mutually exclusive attributes cannot be selected. Preferably, when a partial set of attributes is specified, the attribute wizard generates any characters of a product number that can be determined from those attributes, and when a complete set of attributes is specified, a complete product number is generated.

The attribute logic applied by the attribute wizard preferably enables the wizard to generate product numbers consistent with an existing catalog of products, and also to generate new product numbers that follow the format and syntax of existing product numbers when a customer specifies attributes that are not met by products in the existing catalog but could be configured from the same body of parts.

The wizard preferably applies further logic for performing sales-related functions. For example, where more than one product would satisfy a customer's specified attributes, the logic may selectively provide a product number of a product preferred by the manufacturer.

Configurator

A product number received by the server from the client is provided to the configurator through the server presentation layer application. The configurator may be implemented as a simple database associating parts lists with product numbers, but it is preferably a rules based system that dynamically assembles parts lists and other product specifications by parsing a product number into field values and applying logic to the field values to determine the information to be included in the product specifications.

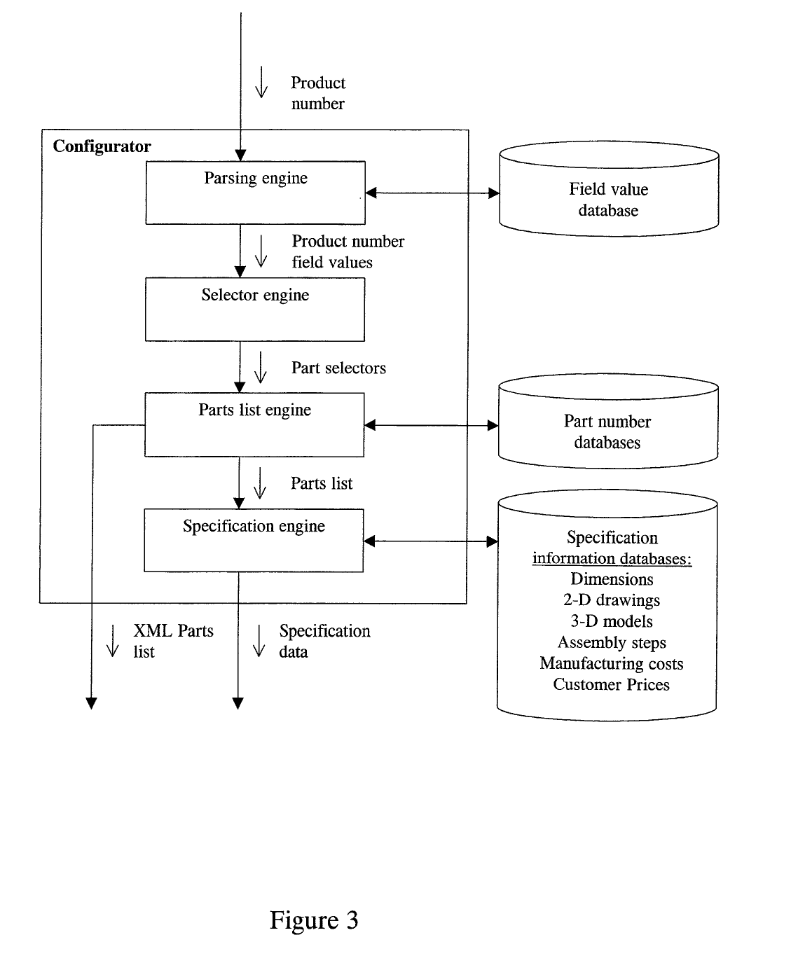

FIG. 3 illustrates a first embodiment of a configurator in accordance with the invention. The input to the configurator is a product number. The product number is parsed by a parsing engine, which assigns each character of the product number to a field within a generic product number structure by referencing data stored in a field value database. For a given product number, the value of each field may consist of no characters of the product number, one character of the product number, or more than one character of the product number.

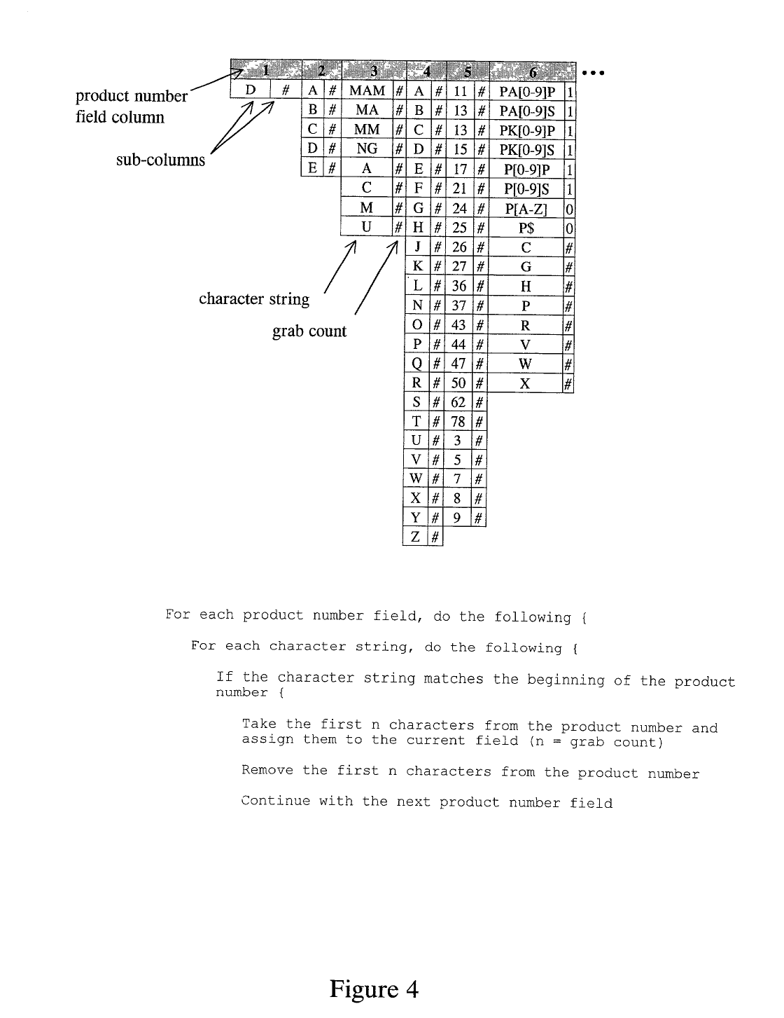

FIG. 4 illustrates a preferred embodiment of a field value database and associated pseudocode for parsing a product number in the parsing engine using the field value database. The field value database is provided in the form of a table in which each column corresponds to a field of the generic product number format. FIG. 4 shows the first six columns of a table for an exemplary product number format. Each column contains two sub-columns, the first containing character strings, and the second containing associated “grab counts”. As described in the corresponding pseudocode, the parsing engine determines a value for each product number field sequentially, beginning with the first field. For each product number field, the character strings in the first sub-column are sequentially compared to the beginning characters of the product number. When a character string in the first sub-column matches the beginning characters of the product number, a number of characters as indicated in the second sub-column are “grabbed,” i.e. removed from the beginning of the product number and assigned to the product number field. The value to be assigned to the second field is then determined using the remaining characters of the product number.

In the table of FIG. 4, the sub-column grab count value “#” indicates that the number of characters grabbed is equal to the number of characters in the associated character string of the first sub-column, the grab count value “1” indicates that one character is grabbed, and the grab count value “0” indicates that a null character (i.e. no character) is grabbed. The use of grab counts that are different in number from their associated character strings allows the parsing engine to look ahead to values beyond those of the immediate field in order to determine the appropriate field value. For example, in the sub-columns under column 6, the grab count for the three character string P[0-9]S is 1, and the grab count of the two character string P[A-Z] is 0. Accordingly, when assigning characters to the sixth field of the product number, if any value P0S-P9S is found at the beginning of the product number, the first character P is assigned to the sixth field and removed from the product number. However, if any value PA-PZ is found at the beginning of the product number, a null character is assigned to the sixth field, and no character is removed from the product number. In this manner the parsing engine is enabled to look forward to additional characters to determine whether a particular character belongs in a given field or a succeeding field.

Referring again to FIG. 3, the output of the parsing engine is product number field values comprising sets of characters associated with each field of the generic product number format. The product number field values are passed to a selector engine, for example, through shared memory space. In the selector engine, to manufacturing rules are applied to the field values to translate the field values into the list of component parts and quantities that make up the product. The manufacturing rules associate specific logical combinations of field values with parts selectors, and the parts selectors in turn correspond to parts records stored in part number databases. The part number databases are preferably grouped by product family. In the embodiment of FIG. 3, the logic applied to the field values is compiled and stored in the selector engine. The output of the selector engine is a group of part selectors that are associated with records containing the specific individual parts that make up the product.

The part selectors are passed to a parts list engine, which retrieves part number records from part number databases and assembles a parts list. The parts lists provides the part number and quantity of each part that makes up the product. The parts list is made available to a specification engine, for example, through shared memory space. In addition, the parts list engine generates an XML parts list that is made available to other applications of the server such as the availability engine. The following is an example of a XML parts list document that could be generated by the parts list engine:

<PRODUCT>

<PRODUCTNUMBER>1535-345-1375</PRODUCTNUMBER>
<FAMILY>D-Sub</FAMILY>
<PARTS>

<PART>
<PARTNUMBER>325535-7456</PARTNUMBER>
<QTY>5</QTY>
<UNIT>PCS</UNIT>

</PART>
<PART>

<PARTNUMBER>412435-1349</PARTNUMBER>
<QTY>3</QTY>
<UNIT>PCS</UNIT>

</PART>
<PART>

<PARTNUMBER>345568-0875</PARTNUMBER>
<QTY>8</QTY>
<UNIT>PCS</UNIT>

</PART>

</PARTS>

</PRODUCT>

The data within the XML document includes values associated with the following predefined elements: product, product number, product family, parts, part, part number, quantity, and unit.

The specification engine applies further manufacturing rules to the parts list data to determine selectors for retrieval of partial specification records from partial specification record databases. In preferred embodiments of the invention, multiple data bases provide records containing types of specification information that partially represent aspects of a product such as dimensional information, 2-D drawings, 3-D models, assembly steps, manufacturing costs, and customer prices. The selectors generated by the specification engine are associated with various partial specification records that are relevant to a particular product. Partial specification records are preferably generic to multiple products, and the specification engine logic is preferably designed to identify all partial specification records relevant to a specific product such that the combination of records produced for the product constitutes a specification that is tailored to that product. Retrieved partial specification records are collected and provided to the presentation layer, where they are formatted for display by the client system.

It is preferred that the manufacturing rules applied by the selector engine are determined through an iterative process. Particularly, a body of product numbers and their corresponding specifications are first provided. Beginning with any product number, a rule for translating a product number field value to a corresponding part selector is proposed. This proposed rule is then applied to all product numbers to generate proposed part selectors for each product. Those selectors are then compared to the actual product specifications. If any proposed selector is associated with a part that is not included in the product, the proposed rule is invalid. The proposed rule is then modified and the modified proposed rule is applied to all existing product numbers to generate new proposed selectors. The process of modification and testing is repeated until a proposed rule produces no proposed selectors that deviate from known specifications. The rule is then adopted and incorporated in the selector engine. It is also preferable for the manufacturing rules applied by the specification engine and the sales rules applied by the product number wizard to be developed through an analogous process.

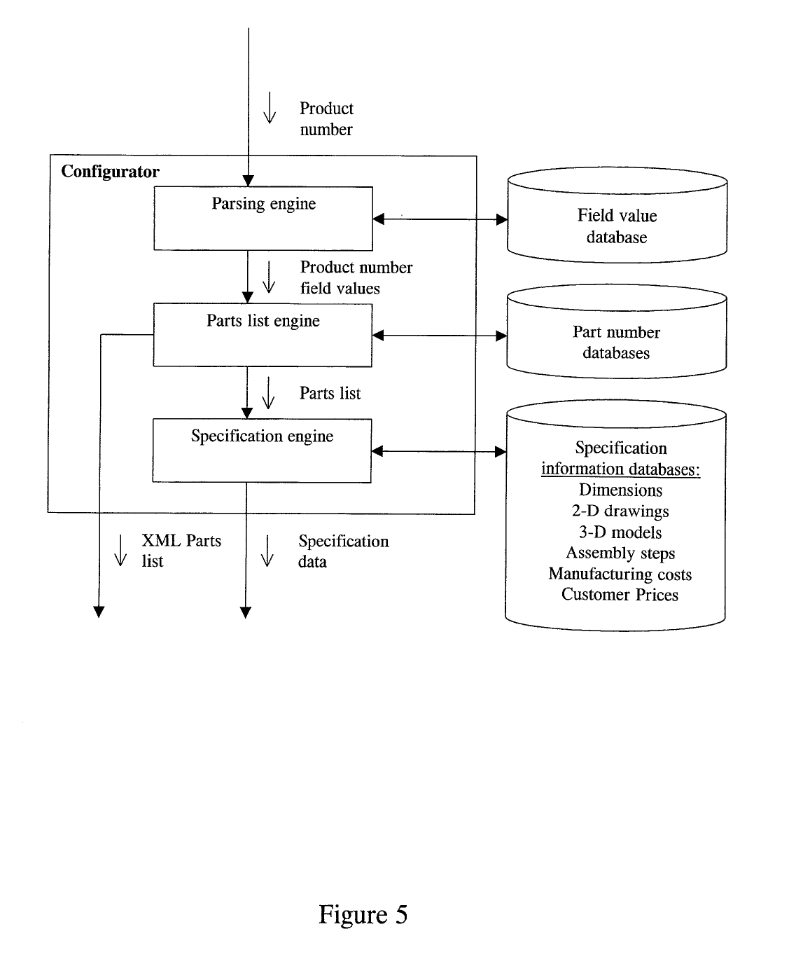

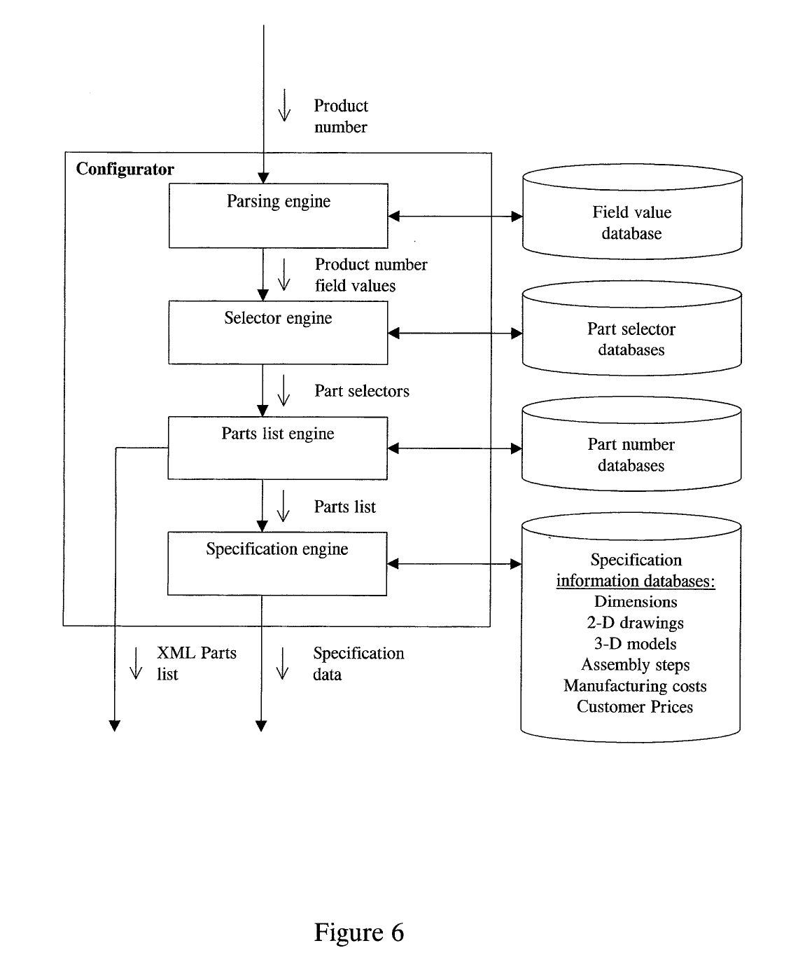

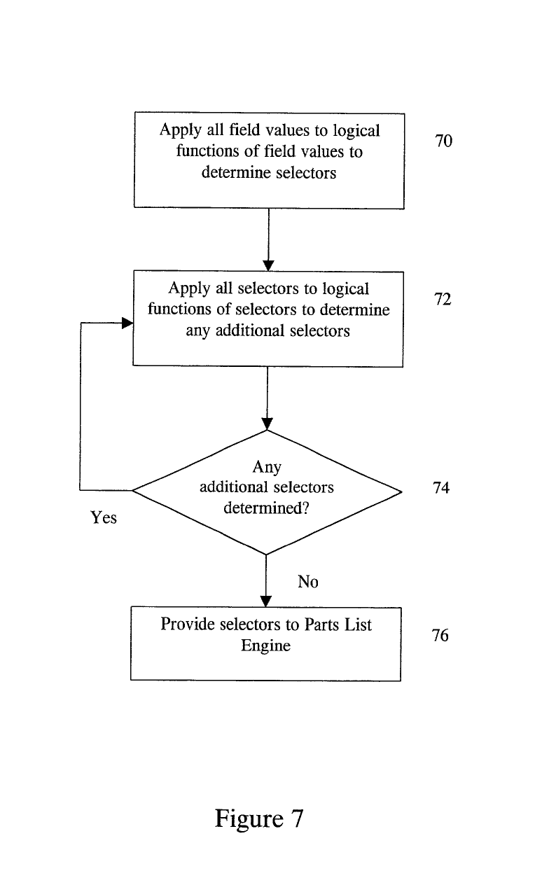

Alternative configurators in accordance with alternative embodiments are illustrated in FIGS. 5 and 6. The configurator of FIG. 5 differs from that of FIG. 3 in that the selector engine is eliminated, and the logic that was implemented in the selector engine of FIG. 3 is relocated to the selector fields of the part number database. In other words, each part record is associated with a selector that takes the form of a logical function of product number field values. Accordingly, rather than applying compiled rules to field values in a selector engine to generate selectors that are then used by the parts list engine, as in FIG. 3, the parts list engine of FIG. 5 applies the rule stored in each selector field of the part number database to a set of specific product number field values, and any part record for which the associated rule provides a true result is retrieved from the database.

The configurator of FIG. 6 differs from that of FIG. 3 in that the logic implemented in the selector engine of FIG. 3 is relocated to the selector fields of field-specific part selector databases. In other words, each selector from the part number database appears as a record in a part selector database, and is associated with another selector that takes the form of a logical rule that operates on field values from the product number. The selector engine applies a set of specific product number field values to each logical rule, and for each rule that produces a true result, the associated parts selector is retrieved. Those parts selectors are then used by the parts list engine to retrieve part records.

In a preferred implementation of the system of FIG. 6, each record in the part selector database may be associated with a logical rule that operates on field values as described above, and may also be associated with a logical rule that operates on the values of selectors. Thus, in accordance with this preferred implementation, the selector engine performs a process as shown in FIG. 7. In this process, the selector engine applies 70 field values to logical functions of field values to determine selectors. Then, determined selectors are applied 72 to logical functions of selectors to determine any additional selectors. If further selectors are determined 74, all determined selectors are again applied to the logical functions of selectors. This is repeated until no new selectors are determined, and then all selectors are provided 76 to the parts list engine.

In the preferred embodiment of FIG. 6, it is also preferable that the part number selectors themselves are comprised of multiple fields that describe different features of the corresponding parts. This embodiment is preferred over those of FIGS. 3 and 5 because it provides the least redundant and most maintainable logic and data storage.

Availability Engine

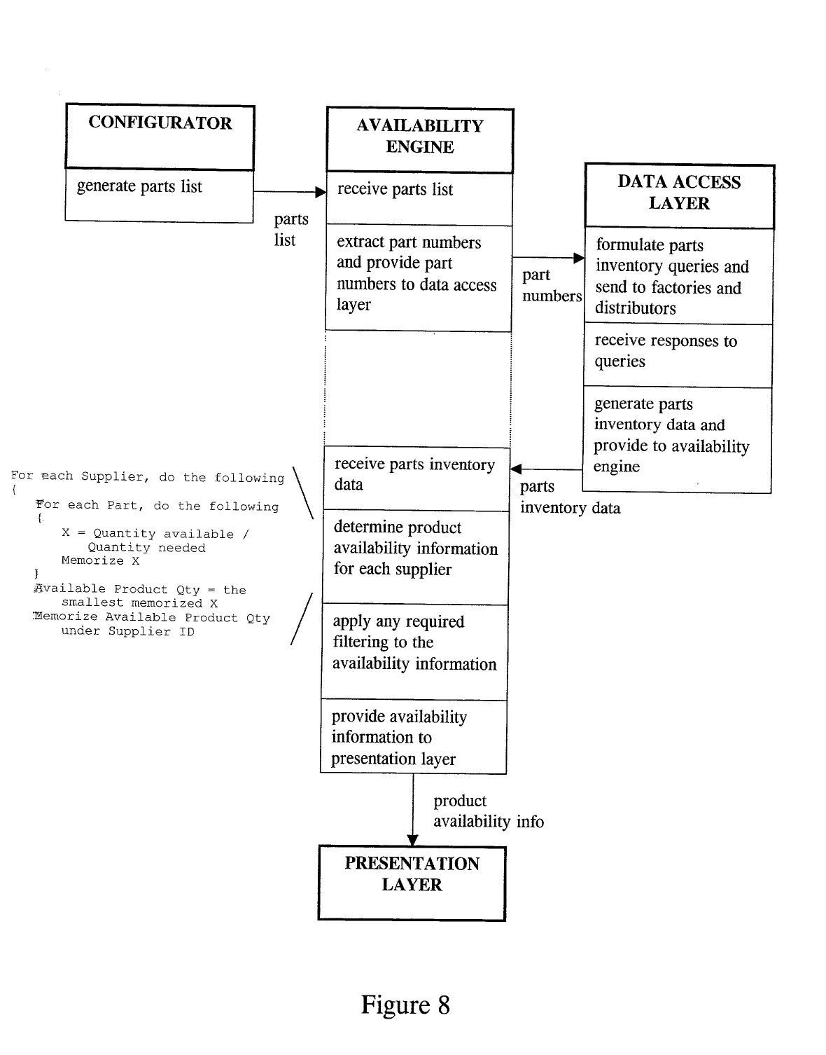

FIG. 8 shows the operation of the availability engine and its interaction with other applications in accordance with a preferred embodiment. Initially, the availability engine receives a parts list from the configurator. An example of an XML parts list is provided above in the discussion of configurators. After receiving the parts list, the availability engine extracts part numbers and provides them to the data access layer. Extraction of part numbers may be done using an XSL processor to filter out data in the parts list that is not associated with <PARTNUMBER> tags, and to generate a second XML document containing only the part number data. The following is an example of XML part number data that could be generated from the parts list above:

<PARTS>

<PART>

<PARTNUMBER>325535-7456</PARTNUMBER>

</PART>
<PART>

<PARTNUMBER>412435-1349</PARTNUMBER>

</PART>
<PART>

<PARTNUMBER>345568-0875</PARTNUMBER>

</PART>

</PARTS>

The data access layer processes the received XML document to formulate queries to the various factory and distributor databases with which the system has connectivity, and sends the queries. The nature and format of the query provided to each supplier depends on the individual supplier's system, and it is preferred that the data access layer includes appropriate programming for generating the required queries. Typically, the queries provide part numbers and request the total number of each part in inventory. After receiving responses to the queries, the data access layer processes the replies to generate parts inventory data for each supplier, and provides the parts inventory data to the availability engine. The parts inventory data is preferably provided as an XML document. The following is an example of an XML document that could be produced by the data access layer to convey parts inventory data:

<PARTS>

<PART>

<PARTNUMBER>325535-7456</PARTNUMBER>
<QTY_AVAILABLE SUPPLIER_ID=“FactoryA”>234</QTY_AVAILABLE>
<QTY_AVAILABLE SUPPLIER_ID=“FactoryB”>344</QTY_AVAILABLE>
<QTY_AVAILABLE SUPPLIER_ID=“DistributorA”>14</QTY_AVAILABLE>
<QTY_AVAILABLE SUPPLIER_ID=“DistributorB”>0</QTY_AVAILABLE>

</PART>
<PART>

<PARTNUMBER>412435-1349</PARTNUMBER>
<QTY_AVAILABLE SUPPLIER_ID=“FactoryA”>4574</QTY_AVAILABLE>
<QTY_AVAILABLE SUPPLIER_ID=“FactoryB”>5477</QTY_AVAILABLE>
<QTY_AVAILABLE SUPPLIER_ID=“DistributorA”>1454</QTY_AVAILABLE>
<QTY_AVAILABLE SUPPLIER_ID=“DistributorB”>765</QTY_AVAILABLE>

</PART>
<PART>

<PARTNUMBER>345568-0875</PARTNUMBER>
<QTY_AVAILABLE SUPPLIER_ID=“FactoryA”>3567</QTY_AVAILABLE>
<QTY_AVAILABLE SUPPLIER_ID=“FactoryB”>954</QTY_AVAILABLE>
<QTY_AVAILABLE SUPPLIER_ID=“DistributorA”>236</QTY_AVAILABLE>
<QTY_AVAILABLE SUPPLIER_ID=“DistributorB”>7367</QTY_AVAILABLE>

</PART>

</PARTS>

The data within the above XML document includes values associated with the following predefined elements: part, part number, and quantity available. The quantity available element has two attributes: supplier ID, and quantity.

The parts inventory data is received by the availability engine, and processed to determine product availability information. Product availability information is broadly defined to encompass any information that indicates whether a product is available from a supplier. Such information may include a simple indication that a product can be obtained from a supplier, or a specific quantity that can be obtained from a supplier, or confirmation of whether a requested quantity can be obtained from a supplier. FIG. 8 includes pseudocode illustrating one example of processing of parts inventory data to generate product availability information. In this example, the maximum number of products that each queried supplier can provide is determined by calculating the number of products for which there is part stock on a per-part basis, and selecting the lowest number. Of course, further calculation may be performed. For example, the resulting available quantities may be compared to a quantity requested by the customer to determine whether the requested quantity is available.

After product availability information is determined, the availability engine applies any necessary filtering to the information to limit the amount of information made available to the customer. For example, if the server is operated by a factory that makes parts and distributes finished products, the factory may selectively make itself known to the user as a potential supplier of a given finished product based on factors such as order volume, order price, type of product, preferred customer status, or the customer's geographic region. Filtering may be optional, such that in some instances no filtering is applied.

After the availability information is filtered, the availability engine provides the filtered availability information to the presentation layer. The information is preferably provided in the form of an XML document. The following is an example of an XML document that could be produced by the availability engine to convey the product availability information:

<PRODUCT>

<PRODUCTNUMBER>1535-345-1875</PRODUCTNUMBER>
<FAMILY>D-Sub</FAMILY>
<QTY_AVAILABLE SUPPLIER_ID=“Factory A”>46</QTY_AVAILABLE>
<QTY_AVAILABLE SUPPLIER_ID=“Factory B”>68</QTY_AVAILABLE>
<QTY_AVAILABLE SUPPLIER_ID=“Distributor A”>2</QTY_AVAILABLE>
<QTY_AVAILABLE SUPPLIER_ID=“Distributor B”>0</QTY_AVAILABLE>
<PARTS>

<PART>

<PARTNUMBER>325535-7456</PARTNUMBER>
<QTY>5</QTY>
<UNIT>PCS</UNIT>

</PART>
<PART>

<PARTNUMBER>412435-1349</PARTNUMBER>
<QTY>3</QTY>
<UNIT>PCS</UNIT>

</PART>
<PART>

<PARTNUMBER>345568-0875</PARTNUMBER>
<QTY>8</QTY>
<UNIT>PCS</UNIT>

</PART>

</PARTS>

</PRODUCT>

The data in the above XML document identifies the product number, its individual parts and their quantities, and the quantity of product available from each of the identified suppliers. The XML document is processed in the presentation layer where it is formatted for display by the client user agent.

In an alternative embodiment, the availability engine may be augmented to query suppliers for information using both parts list data and product numbers. In this manner, the resulting product availability information will reflect any finished product inventory that the supplier may have on hand.

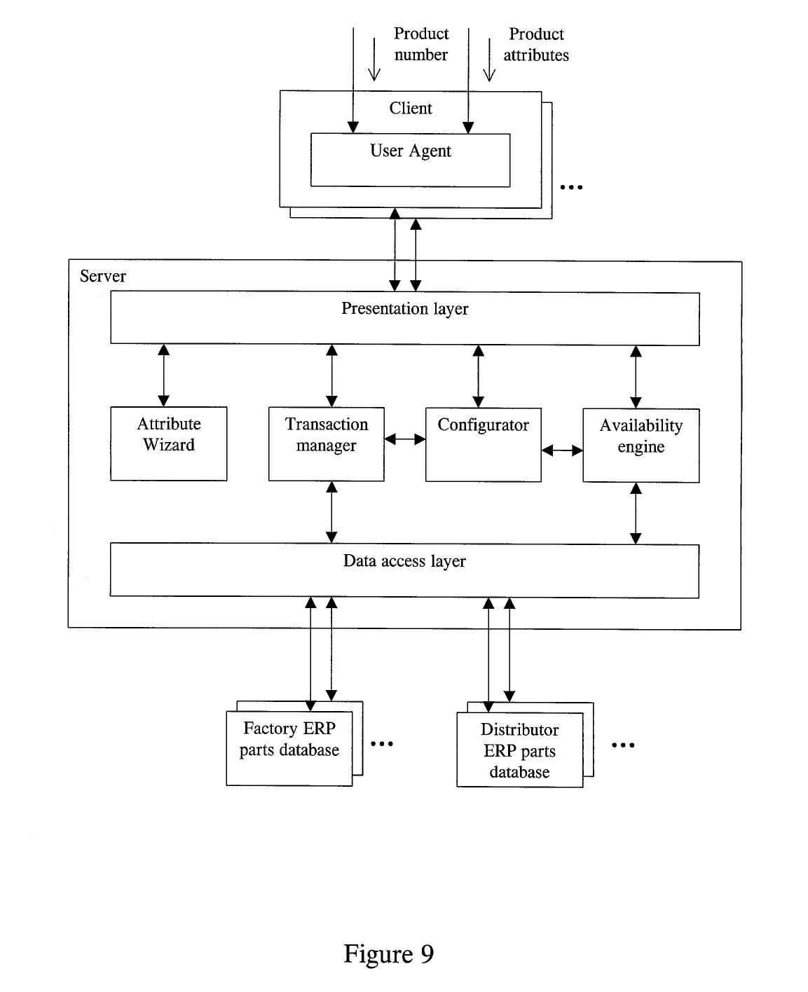

FIG. 9 illustrates a further embodiment of the invention, in which the system provides e-commerce services such as initiating transactions with the manufacturer and distributors. As shown in FIG. 9, this system adds a transaction manager to the system of FIG. 1. A transaction request is generated by the client user agent and is provided to the transaction manager through the presentation layer. The transaction request may include information such as a product number and quantity, a customer identifier, supplier identifier, and terms of delivery. The transaction request is preferably provided in the form of an XML document. In practice, the transaction request process may be automated through a user interface that makes available a transaction screen upon determination or receipt of a product number. The transaction request is processed by the transaction manager and forwarded to a factory order system or distributor order system as appropriate. The transaction request generated by the transaction manager may include additional product information such as a parts list and assembly process specifications to enable the assembly of the finished connector. Upon receiving and processing the transaction request, the distributor or manufacturer returns a transaction confirmation to the transaction manager that is forwarded to the customer. It is preferable in addition for the transaction manager to provide order tracking and delivery status.

It will be appreciated by those of ordinary skill in the art that the client and servers described above may be implemented on computing devices controlled by appropriate programming instructions. Accordingly, embodiments of the invention may comprise a computing device including a processor to execute programming instructions and a storage device coupled to the processor and containing programming instructions for providing the components of the client or server. Appropriate storage devices may include but are not limited to volatile memory such as RAM, and non-volatile memory such as a flash memory or peripheral storage devices such as hard disks and optical disks.

The foregoing description relates to preferred embodiments of the invention. However, those having ordinary skill in the art will recognize a variety of alternative organizations and implementations that fall within the spirit and scope of the invention as defined by the following claims.

What is claimed is:

1. A system for determining availability of a configurable product, comprising:
a processor to execute programming instructions; and
a storage device coupled to the processor and having stored therein programming instructions to be executed by the processor, the programming instructions when executed providing system components including:
a presentation layer providing communication with a client through the internet;
a configurator for generating a parts list corresponding to a product number received from the client;
a data access layer for obtaining inventory data for each part included in the parts list from at least one supplier parts database; and
an availability manager for determining product availability information for each of the at least one suppliers using the parts list and the suppliers' respective inventory data.

2. The system claimed in claim 1, wherein the product availability information is formatted by the presentation layer and provided to the client through the internet.

3. The system claimed in claim 1, wherein the parts list identifies a plurality of parts and a quantity associated with each part.

4. The system claimed in claim 1, wherein the configurator is a rules based configurator.

5. The system claimed in claim 1, wherein the configurator comprises:
a parsing engine for determining field values contained in the product number; and
a parts list engine for producing a parts list by applying logic to the field values.

6. The system claimed in claim 5, wherein the logic is stored as logical functions associated with parts in a parts database.

7. The system claimed in claim 1, wherein the configurator comprises:
a parsing engine for determining field values contained in the product number;
a selector engine for determining part database selectors by applying logic to the field values; and
a parts list engine for producing a parts list by retrieving records from a part database using the selectors.

8. The system claimed in claim 7, wherein the logic comprises compiled logic stored in the selector engine.

9. The system claimed in claim 7, wherein the logic is stored as logical functions associated with selectors in a selector database.

10. The system claimed in claim 1, further comprising a specification engine for producing specification data using the parts list.

11. The system claimed in claim 1, wherein the product availability information comprises a quantity of the product available from each of the at least one the suppliers.

12. A process in a system for determining availability of a configurable product, comprising:
receiving a product number from a client through the internet;
generating a parts list corresponding to the product number;
obtaining inventory data for each part included in the parts list from a part database of at least one supplier;
determining product availability information for each of the at least one suppliers using the parts list and the suppliers' respective inventory data; and
providing the availability information for each of the at least one suppliers to the client through the internet.

13. The process claimed in claim 12, wherein generating a parts list comprises:
parsing the product number to determine field values contained in the product number; and
applying logic to the field values to generate the parts list.

14. The process claimed in claim 13, wherein the logic comprises compiled logic stored in a selector engine.

15. The process claimed in claim 13, wherein the logic comprises logical functions associated with part selectors in a selector database.

16. The process claimed in claim 13, wherein the logic comprises logical functions associated with parts in a parts database.

17. The process claimed in claim 12, wherein the parts list identifies a plurality of parts and a quantity associated with each part.

18. The process claimed in claim 12, wherein determining product availability information comprises determining a maximum quantity of product available from each supplier.

19. The process claimed in claim 12, wherein the product availability information is filtered prior to providing the product availability information to the client.

20. The process claimed in claim 12, further comprising:
producing specification data using the parts list;
formatting the specification data for display by the client; and
providing the specification data to the client.

21. A rules based configurator for generating a parts list for a product, comprising:
a processor to execute programming instructions;
a part number database associating parts data with logical functions of field values; and
a storage device coupled to the processor and having stored therein programming instructions to be executed by the processor, the programming instructions when executed providing system components including:
a parsing engine generating product field values from a product number, the field values comprising sets of characters of the product number associated with fields of a generic product number format; and
a parts list engine applying the product field values to logical functions stored in the part number database to yield a parts list corresponding to the product number.

22. The rules based configurator claimed in claim 21, the programming instructions further providing a specification engine for producing specification data using the parts list.

23. The rules based configurator claimed in claim 21, wherein the parts list engine provides the parts list as an XML document.

24. A method for generating a parts list for a product, comprising:
generating product field values from a product number, the field values comprising sets of characters of the product number associated with fields of a generic product number format; and
applying the product field values to logical functions of field values stored in a part number database in association with parts data;
retrieving parts data associated with each logical function for which application of the product field values produces a true result; and
generating a parts list from the retrieved parts data.

25. The method claimed in claim 24, further comprising providing the parts list as an XML document.

26. The method claimed in claim 24, further comprising producing specification data using the parts list.

27. A rules based configurator for generating a parts list corresponding to a product number, comprising:
a processor to execute programming instructions;
a part number database associating parts data with part selectors;
a selector database associating part selectors of the part number database with logical functions of field values; and
a storage device coupled to the processor and having stored therein programming instructions to be executed by the processor, the programming instructions when executed providing system components including:
a parsing engine generating product field values from a product number, the field values comprising sets of characters of the product number associated with fields of a generic product number format;
a selector engine applying the product field values to logical functions stored in the selector database to determine part selectors corresponding to the product number; and
a parts list engine retrieving parts data corresponding to determined part selectors to generate a parts list corresponding to the product number.

28. The rules based configurator claimed in claim 27, wherein the selector database further associates logical functions of part selectors with part selectors, and
wherein the selector engine further applies determined part selectors to logical functions of part selectors stored in the selector database to determine additional selectors corresponding to the product number.

29. The rules based configurator claimed in claim 27, the programming instructions further providing a specification engine for producing specification data using the parts list.

30. The ruled based configurator claimed in claim 28, wherein the parts list engine provides the parts list as an XML document.

31. A method for generating a parts list for a product, comprising:
generating product field values from a product number, the field values comprising sets of characters of the product number associated with fields of a generic product number format;
applying the product field values to logical functions of field values associated with part selectors to determine part selectors corresponding to the product number; and
retrieving parts data corresponding to determined part selectors to generate a parts list corresponding to the product number.

32. A method as claimed in claim 31, further comprising providing the parts list as an XML document.

33. A method as claimed in claim 31, further comprising producing specification data using the parts list.

34. A method as claimed in claim 31, further comprising applying determined part selectors to logical functions of part selectors associated with part selectors to determine any additional part selectors corresponding to the product number.
